(19) United States
(12) Patent Application Publication
(10) Pub. No.: US 2016/0172692 A1
(43) Pub. Date: Jun. 16, 2016

(54) DIFFUSION MEDIUM FOR USE IN FUEL CELL, FUEL CELL AND METHOD OF MAKING THE DIFFUSION MEDIUM

(71) Applicant: TEMASEK POLYTECHNIC, Singapore (SG)

(72) Inventors: Ming HAN, Singapore (SG); He Ho Gareth TANG, Singapore (SG); Yunzhong CHEN, Singapore (GB)

(21) Appl. No.: 14/905,335

(22) PCT Filed: Jul. 17, 2013
(86) PCT No.: PCT/SG2013/000296

§ 371 Date: Jan. 15, 2016

(51) Int. Cl. H01M 8/04119; H01M 8/0239; H01M 8/0234; H01M 8/0243

(52) U.S. Cl. CPC H01M 8/04149; H01M 8/0243; H01M 8/0239; H01M 8/0234

(57) ABSTRACT

A diffusion medium (10) for use in a fuel cell, a fuel cell (80) and a method (60) of making the diffusion medium (10) are provided. The diffusion medium (10) includes a porous substrate (12) having a first surface (14) and a second surface (16), a microporous layer (18) formed on the first surface (14) of the porous substrate (12), and a plurality of water-retaining portions (20) formed on the microporous layer (18). The porous substrate (12) is electrically conductive. The microporous layer (18) provides a hydrophobic surface (22). The water-retaining portions (20) define a hydrophilic area (24) on the hydrophobic surface (22) of the microporous layer (18).

### FIELD OF THE INVENTION

The present invention relates to fuel cell technology and more particularly o a diffusion medium for use in a fuel cell, a fuel cell employing the same, and a method of making the diffusion medium.

### BACKGROUND OF THE INVENTION

Auxiliary components, such as pumps, air compressors, humidifiers, fans, heat exchangers and electronic controllers, are provided in polymer electrolyte membrane (PEM) fuel cell power systems to facilitate stable operation of the fuel cells. These components are often referred to as the balance of plant (BOP) of a fuel cell. Apart from reactant supply, the main functions of these components are water and thermal management so as to prevent unfavourable dehydration of the membrane at high temperatures.

A drawback though is that the provision of such components adds to the cost of a fuel cell power system. Additionally, the provision of such components also induces additional parasitic power consumption and increases the mass and complexity of the fuel cell power system.

To address these issues, several self-humidification techniques have been proposed. Unfortunately, there are problems with the current proposed techniques. For example, one proposal is to add silica or metal oxide to the proton conductive membrane as water retainers. However, this technique compromises the conductivity and durability of the membrane. Repeated operating cycles of expansion and contraction increase the mechanical stresses on the membrane and loss of the metal oxide degrades the long term performance of the membrane. Another proposed technique involves introducing water retainers into catalyst support material or mixing the water retainers with the catalyst. However, these measures compromise the chemical stability of the catalyst.

In view of the above, it is desirable to provide a fuel cell component that provides self-humidification and high temperature tolerance capabilities, without compromising the durability of other critical components of a fuel cell such as the catalysts and the membrane.

### SUMMARY OF THE INVENTION

Accordingly, in a first aspect, there is provided a diffusion medium for use in a fuel cell. The diffusion medium includes a porous substrate having a first surface and a second surface, a microporous layer formed on the first surface of the porous substrate, and a plurality of water-retaining portions formed on the microporous layer. The porous substrate is electrically conductive. The microporous layer provides a hydrophobic surface. The water-retaining portions define a hydrophilic area on the hydrophobic surface of the microporous layer.

In a second aspect, there is provided a fuel cell including a membrane having an anode side and a cathode side. A first diffusion layer is provided on the anode side of the membrane. The first diffusion layer is arranged to receive a fuel flow. A second diffusion layer is provided on the cathode side of the membrane. The second diffusion layer is arranged to receive an oxidant flow and includes a diffusion medium according to the first aspect.

In a third aspect, there is provided a method of making a diffusion medium for use in a fuel cell. The method includes providing a porous substrate having a first surface and a second surface. The porous substrate is electrically conductive. A microporous layer is formed on the first surface of the porous substrate. The microporous layer provides a hydrophobic surface. A plurality of water-retaining portions is formed on the microporous layer. The water-retaining portions define a hydrophilic area on the hydrophobic surface of the microporous layer.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1 is an enlarged schematic cross-sectional view of a diffusion medium for use in a fuel cell in accordance with one embodiment of the present invention;

FIG. 2 is an enlarged schematic top plan view of the diffusion medium of FIG. 1;

FIG. 3 is an enlarged top plan view of the diffusion medium of FIG. 2 after being subjected to a dip test;

FIG. 4 is an enlarged schematic top plan view of a diffusion medium for use in a fuel cell in accordance with another embodiment of the present invention;

FIG. 5 is an enlarged schematic top plan view of a diffusion medium for use in a fuel cell in accordance with yet another embodiment of the present invention;

FIG. 6 is a schematic flow diagram illustrating a method of making a diffusion medium for use in a fuel cell in accordance with an embodiment of the present invention;

FIG. 7 is a schematic cross-sectional view of a fuel cell employing the diffusion medium of FIG. 1;

FIG. 8 is a schematic diagram of a fuel cell assembly employing the fuel cell of FIG. 7;

FIG. 9 is a graph comparing a maximum power density of a fuel cell in accordance with one embodiment of the present invention against a maximum power density of a conventional fuel cell at various operating temperatures; and

FIG. 10 is a graph of a chronoamperometry curve of a fuel cell in accordance with one embodiment of the present invention.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

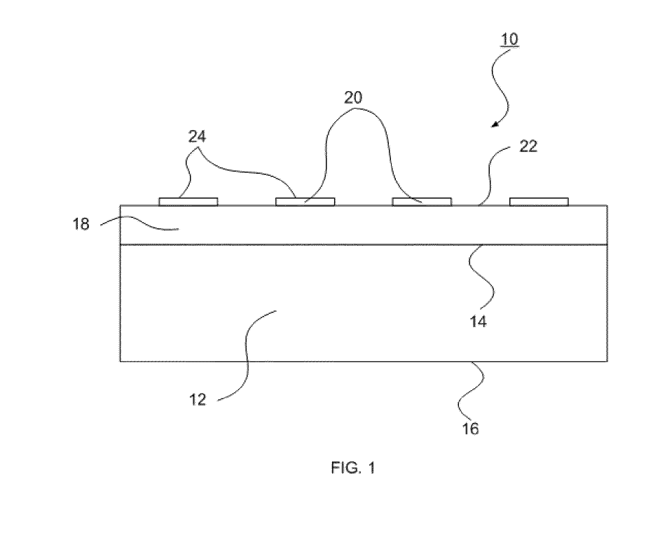

Referring now to FIG. 1, an enlarged schematic cross-sectional view of a diffusion medium 10 for use in a fuel cell is shown. The diffusion medium 10 includes a porous substrate 12 having a first surface 14 and a second surface 16, a microporous layer (MPL) 18 formed on the first surface 14 of the porous substrate 12 and a plurality of water-retaining portions 20 formed on the microporous layer 18. The microporous layer 18 provides a hydrophobic surface 22 and the water-retaining portions 20 define a hydrophilic area 24 on the hydrophobic surface 22 of the microporous layer 18. The porous substrate 12 is electrically conductive.

The diffusion medium 10 may be employed as a gas diffusion layer (GDL) in a fuel cell. Advantageously, the provision of the water-retaining portions 20 on the hydrophobic surface 22 of the microporous layer 18 endows the diffusion medium 10 with dual-function capabilities: gas diffusion and water retention capabilities.

In the present embodiment, the porous substrate 12 has a matrix structure. The porous substrate 12 may be carbonized felt, carbon paper or carbon cloth. Non-woven carbon paper and woven carbon cloth are commercially available. In non-woven processing, the carbon paper is produced through high temperature graphitization of organic fibres that are soaked with resin and dried. An interconnected network is formed from the graphitized resin to hold the graphitized fibres together. Macroporous pores are formed during the graphitization. In woven processing, the fibres are woven into cloth before high temperature graphitization. In the present embodiment, the porous substrate 12 is hydrophobic treated to make the porous substrate 12 hydrophobic. This may be, for instance, by adding a hydrophobic material such as polytetrafluoroethylene (PTFE) into the porous substrate 12. The porous substrate 12 may be hydrophobic treated before or after applying the microporous layer 18 on the first surface 14 of the porous substrate 12. In the present embodiment, the porous substrate 12 is hydrophobic treated before the water-retaining portions 20 are formed on the microporous layer 18.

The microporous layer 18 is a thin layer having a plurality of pores of micro dimensions. The function of the microporous layer 18 is to provide proper pore structure and hydrophobicity to facilitate gas transport to and water removal from a catalyst layer and also to minimize electrical contact resistance with an adjacent catalyst layer. In the present embodiment, the microporous layer 18 is made up of a mixture of a plurality of carbon nanoparticles and a hydrophobic agent such as PTFE. Although illustrated in the present embodiment as being formed on one side of the porous substrate 12, it should be appreciated by those of ordinary skill in the art that the present invention is not limited to diffusion mediums having a microporous layer applied on only one side of the porous substrate 12. In an alternative embodiment, the microporous layer 18 may be formed on both the first and second surfaces 14 and 16 of the porous substrate 12.

In the present embodiment, the water-retaining portions 20 are made of a hydrophilic polymer and an electron conductive material. The water-retaining portions 20 of the present embodiment are therefore electrically conductive. The electron conductive material may be a plurality of carbon nanoparticles, a plurality of carbon nanotubes, a graphite powder and/or a plurality of chopped carbon fibres. In the present embodiment, the water-retaining portions 20 also contain a proton conductive polymer. The proton conductive polymer may be Nafion®, sulfonated polyphosphazene, sulfonated poly(ether ether ketone) (SPEEK) or derivatives thereof. In one embodiment, a ratio by weight of the electron conductive material to the proton conductive polymer is 1:3. Advantageously, as the water-retaining portions 20 are deposited on the hydrophobic surface 22 of the microporous layer 18, the hydrophobicity of the microporous layer 18 beneath the water-retaining portions 20 helps to prevent water retained in the water-retaining portions 20 from seeping through to the porous substrate 12.

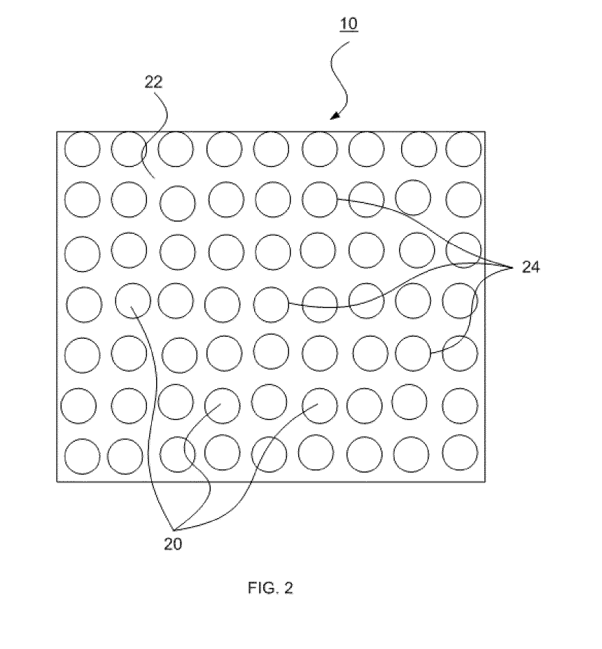

Referring now to FIG. 2, an enlarged schematic top plan view of the diffusion medium 10 of FIG. 1 is shown. As can be seen from FIG. 2, the water-retaining portions 20 are formed in a patterned arrangement on the hydrophobic surface 22 of the microporous layer 18. The patterned arrangement in the embodiment shown comprises a plurality of circular-shaped water-retaining portions 20 distributed in a matrix over the hydrophobic surface 22 of the microporous layer 18. The remaining surface area uncovered by the water-retaining portions 20 is a hydrophobic area.

The function of the hydrophilic area 24 defined by the water-retaining portions 20 is water retention and the function of the remaining hydrophobic area is gas diffusion. With the patterned arrangement of the water-retaining portions 20 on the hydrophobic surface 22 of the microporous layer 18, water retention is confined to the hydrophilic area 24 and gas diffusion occurs through the hydrophobic area and is not impeded by the retention of water in the diffusion medium 10. Advantageously, retention of water in the water-retaining portions 20 facilitates humidification of the proton conductive membrane in a fuel cell and this enhances the fuel cell performance, particularly at high temperatures where dehydration of the membrane is more of a concern than flooding.

In preferred embodiments, the hydrophilic area 24 covers between about 2 percent (%) and about 40% of the hydrophobic surface 22 of the microporous layer 18. The proportion of the hydrophilic area 24 relative to the hydrophobic surface 22 of the microporous layer 18 is variable by adjusting the dimension and density of the water-retaining portions 20.

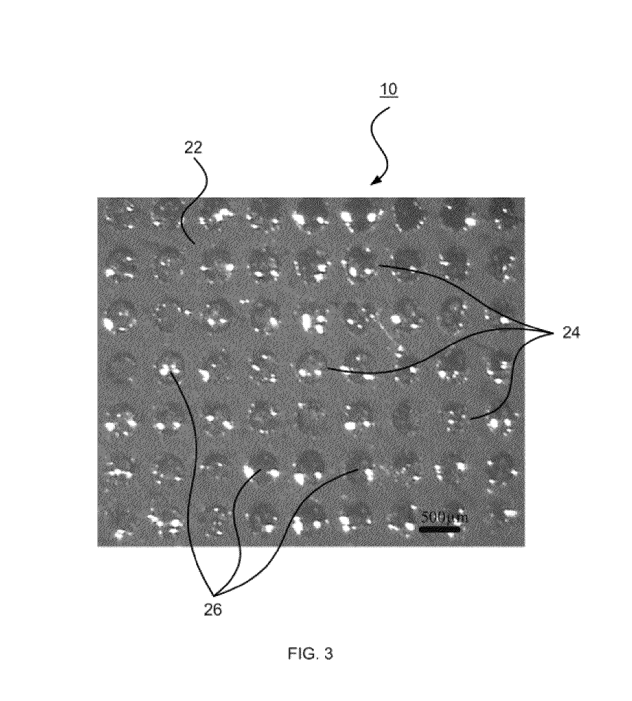

Referring now to FIG. 3, an enlarged top plan view of the diffusion medium 10 of FIG. 2 after being subjected to a dip test is shown. The dip test is performed by dipping the diffusion medium 10 in de-ionized water for three (3) seconds (s). In the embodiment shown, the hydrophilic area 24 covers about 36% of the hydrophobic surface 22 of the microporous layer 18. As can be seen from FIG. 3, a plurality of water droplets 26 are clearly observed under microscopy on the hydrophilic area 24 defined by the water-retaining portions 20 after dipping the diffusion medium 10 in de-ionized water. No water is observed on the hydrophobic surface 22 of the microporous layer 18 where none of the water-retaining portions 20 are applied.

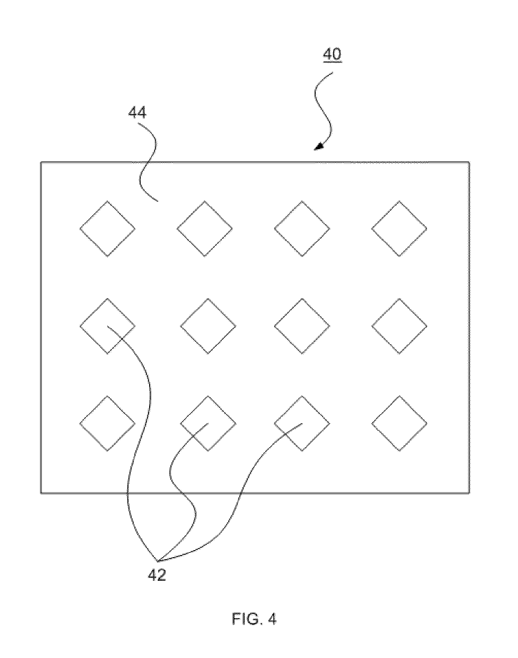

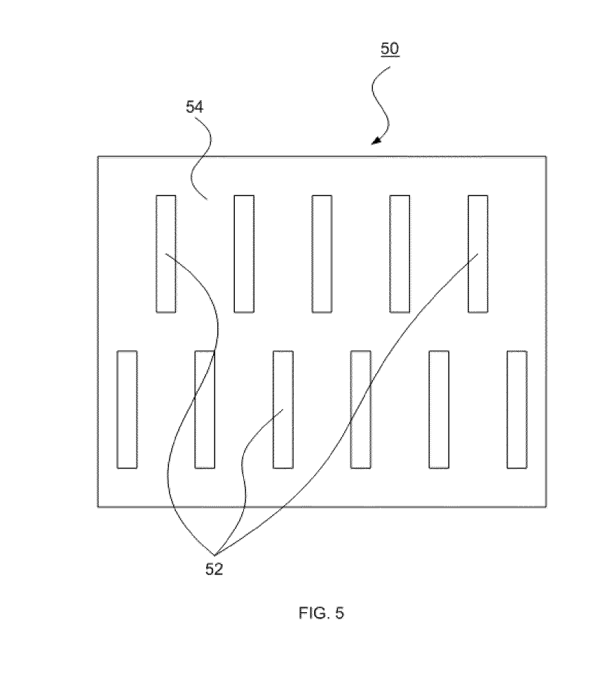

Although illustrated as being circular-shaped in FIGS. 2 and 3, it should be understood by those of ordinary skill in the art that the water-retaining portions 20 of the present invention are not limited to being circular-shaped. Alternative shapes and layouts of the water-retaining portions 20 are encompassed within the scope of the present invention. Examples of these are described below with reference to FIGS. 4 and 5.

Referring now to FIG. 4, an enlarged schematic top plan view of a diffusion medium 40 in accordance with another embodiment of the present invention is shown. In the embodiment shown, the patterned arrangement comprises a plurality of square-shaped water-retaining portions 42 distributed in an array over a hydrophobic surface 44 of a microporous layer.

Referring next to FIG. 5, an enlarged schematic top plan view of a diffusion medium 50 in accordance with yet another embodiment of the present invention is shown. In this embodiment, the patterned arrangement comprises a plurality of water-retaining strips 52 distributed in an array over a hydrophobic surface 54 of a microporous layer.

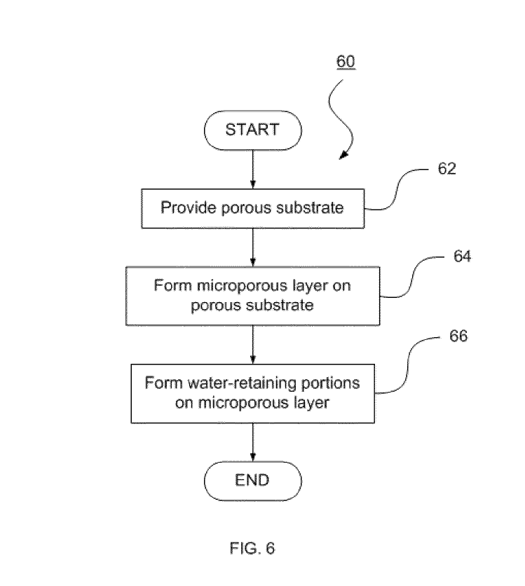

A method of making the diffusion medium 10 of FIG. 1 will now be described below with reference to FIG. 6.

Referring now to FIG. 6, a method 60 of making a diffusion medium 10 for use in a fuel cell is shown. The method 60 begins at step 62 by providing a porous substrate 12 having a first surface 14 and a second surface 16. The porous substrate 12 is electrically conductive.

At step 64, a microporous layer 18 is formed on the first surface 14 of the porous substrate 12. The microporous layer 18 provides a hydrophobic surface. In one embodiment, the microporous layer 18 is formed by preparing a mixture paste of carbon black and polytetrafluoroethylene (PTFE) and depositing the paste onto the first surface 14 of the porous substrate 12 using a technique such as painting, brushing, printing, spraying or screen printing.

A plurality of water-retaining portions 20 is formed on the microporous layer 18 at step 66. The water-retaining portions 20 define a hydrophilic area 24 on the hydrophobic surface 22 of the microporous layer 18.

In the present embodiment, the step of forming the water-retaining portions 20 on the microporous layer 18 involves applying a water retaining ink on the hydrophobic surface 22 of the microporous layer 18 to form the water-retaining portions 20. The water retaining ink may be applied on the hydrophobic surface 22 of the microporous layer 18 using a technique such as painting, brushing, printing, spraying or screen printing. Spraying or brushing may be performed with a patterned mask. Screen printing may be preferred for large-scale manufacture as higher productivity is achievable with screen printing. An additional heating process at about 350 degrees Celsius (° C.) for about half an hour may be applied to enhance the adhesion of the water-retaining portions 20 to the microporous layer 18.

The water retaining ink of the present embodiment is made of a hydrophilic polymer. In the present embodiment, the water retaining ink includes an electron conductive material such as graphite powder and a proton conductive polymer such as Nafion®. In one embodiment, the water retaining ink comprises a mixture of a plurality of carbon nanoparticles in a 5 weight 20 percent (wt %) Nafion® solution. In the same or a different embodiment, a ratio by weight of the carbon nanoparticles to Nafion® in the solution is 1:3.

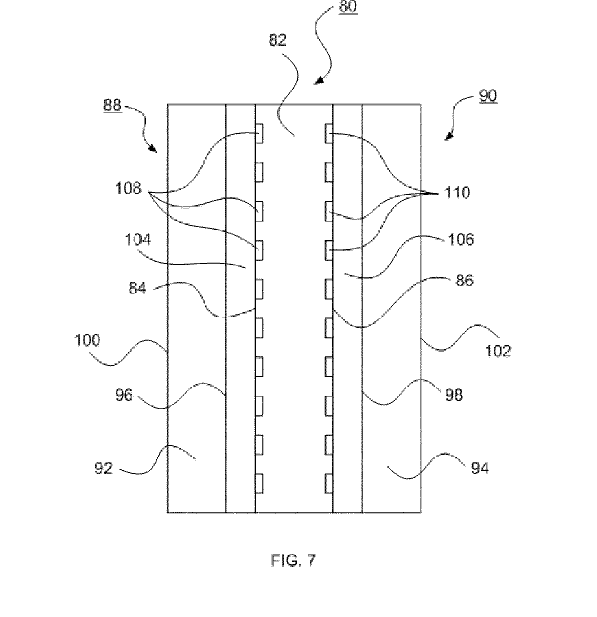

Referring now to FIG. 7, a schematic cross-sectional view of a fuel cell 80 employing the diffusion medium 10 of FIG. 1 is shown. The fuel cell 80 includes a membrane 82 having an anode side 84 and a cathode side 86. A first diffusion layer 88 is provided on the anode side 84 of the membrane 82. The first diffusion layer 88 is arranged to receive a fuel flow. A second diffusion layer 90 is provided on the cathode side 86 of the membrane 82. The second diffusion layer 90 is arranged to receive an oxidant flow.

As can be seen from FIG. 7, the membrane 82 is sandwiched between a pair of gas diffusion layers (GDLs) 88 and 90. In the present embodiment, the membrane 82 is a catalyst coated membrane (CCM). The catalyst coated membrane of the present embodiment is a proton conductive membrane with catalysts coated on both the anode and cathode sides 84 and 86. The catalysts may be platinum or ruthenium containing materials or alloys thereof.

The gas diffusion layers 88 and 90 have a porous structure for the purpose of reactant distribution. In the present embodiment, each of the first and second diffusion layers 88 and 90 corresponds to the diffusion medium 10 of FIG. 1. Accordingly, each of the first and second diffusion layers 88 and 90 includes an electrically conductive porous substrate 92 and 94 having a first surface 96 and 98 and a second surface 100 and 102, a microporous layer (MPL) 104 and 106 formed on the first surface 96 and 98 of the porous substrate 92 and 94 and a plurality of water-retaining portions 108 and 110 formed on the microporous layer 104 and 106.

Although both the first and second diffusion layers 88 and 90 in the embodiment shown correspond to the diffusion medium 10 of FIG. 1, it should be understood by those of ordinary skill in the art that the present invention is not limited to fuel cells having the diffusion medium of the present invention provided on both the anode and cathode sides 84 and 86 of the membrane 82. For instance, the diffusion medium 10 of the present invention may be provided on only the cathode side 86 of the membrane 82 in an alternative embodiment.

In the embodiment shown, the water-retaining portions 108 of the first diffusion medium 88 are in contact with the anode side 84 of the membrane 82 and the water-retaining portions 110 of the second diffusion medium 90 are in contact with the cathode side 86 of the membrane 82. Close contact between the water-retaining portions 108 and 110 as well as the hydrophobic areas of the microporous layer 104 and 106 with the anode and cathode sides 84 and 86 of the membrane 82 facilitates distribution of gases from respective ones of the flow channels to the membrane 82 as well as retention of a quantity of water or moisture created in the fuel cell 80. The latter helps keep the membrane 82 in a saturated condition. The water-retaining function of the water-retaining portions 108 and 110 helps to prevent the membrane 82 from dehydration, even at relatively high operating temperatures. Consequently, the fuel cell 80 is capable of being operated stably at high operating temperatures without compromising the output power density or the durability of critical parts of the fuel cell 80 such as the catalysts and the membrane 82.

In use, the fuel flow, for example, a flow of hydrogen gas, received by the first diffusion layer 88 diffuses through the porous surface of the first diffusion layer 88 and reaches the catalysts on the anode side 84 of the membrane 82 where fuel is split into protons and electrons. The protons pass through the membrane 82 to the cathode side 86 where the protons combine with oxidant in the oxidant flow as well as electrons arriving from an external circuit (not shown) and water is formed in the process. Electricity is generated through the flow of electrons in the external circuit. The water generated at the cathode side 86 helps to keep the membrane 82 saturated with water. This is beneficial for proton diffusion through the membrane 82 and minimizes ohmic loss.

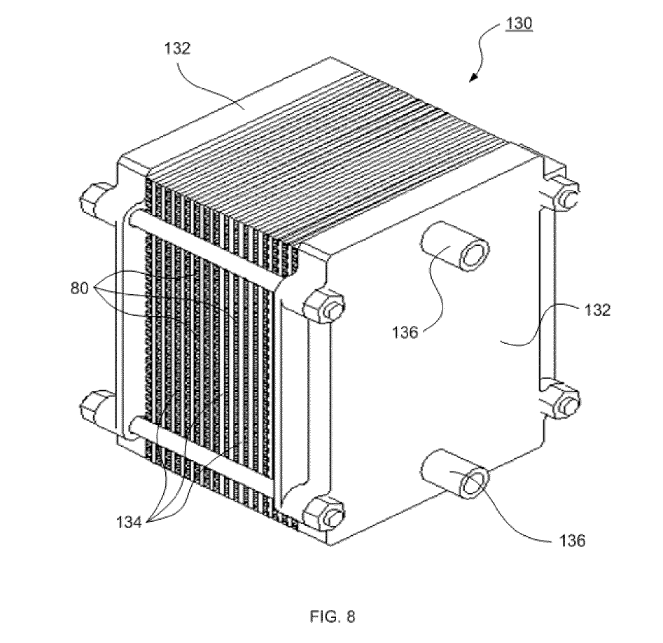

Referring now to FIG. 8, a fuel cell assembly 130 employing the fuel cell 80 of FIG. 7 is shown. The fuel cell assembly 130 includes a plurality of fuel cells 80 stacked together between a pair of endplates 132. Respective ones of a plurality of separators 134 are interposed between adjacent ones of the fuel cells 80. A plurality of flow ports 136 are mounted on the endplate 132 for reactant supply. A plurality of flow channels (not shown) are provided inside the fuel cell assembly 130. The flow channels are connected to the flow ports 136 and deliver fuel and oxidant to respective ones of the fuel cells 80.

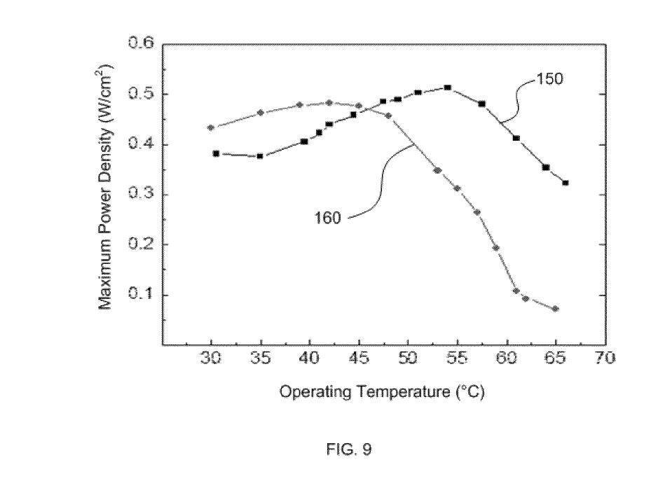

An experiment comparing the performance of a fuel cell in accordance with one embodiment of the present invention against that of a conventional fuel cell was conducted. The fuel cell employed in the experiment is a close cathode single cell fabricated by sandwiching a catalyst-coated membrane (CCM) between a pair of gas diffusion layers (GDLs) formed in accordance with one embodiment of the present invention. The surfaces of the gas diffusion layers with the water-retaining portions are directly contacted with the respective surfaces of the catalyst-coated membrane. The fuel cell has an active area of 14.88 square centimetres (cm²) and was tested in ambient humidity without an external humidifier or cooling device. The pressure of the hydrogen flow was 1.4 bar or 140 kilopascal (kPa). A pump was used to draw air into the fuel cell. The output power at various operating temperatures was measured. The conventional fuel cell was similarly built except that conventional gas diffusion layers were employed in the conventional fuel cell. The conventional fuel cell was also tested under the same conditions. The results of the experiment are plotted in a graph shown in FIG. 9 and discussed below.

Referring now to FIG. 9, a graph comparing a maximum power density 150 of a fuel cell in accordance with one embodiment of the present invention against a maximum power density 160 of a conventional fuel cell at various operating temperatures is shown. As can be seen from FIG. 9, the output power density 150 and 160 of both fuel cells are comparable at the low temperature region. However, the output power density 160 of the conventional fuel cell begins to drop at operating temperatures greater than about 45 degrees Celsius (° C.) and falls sharply as the operating temperature is increased beyond that. Consequently, cooling devices such as fans are required for coercive cooling in conventional fuel cell systems.

In contrast, the maximum power output 150 of the fuel cell of the present embodiment increases continuously with increasing operating temperatures until an operating temperature of around 55° C. Even so, the power output 150 remains at a favourable level—around four (4) times that of its counterpart—at operating temperatures as high as 60° C. Advantageously, the provision of the water-retaining portions in the gas diffusion layers of the present embodiment helps to keep the membrane in a favourable saturated condition. Consequently, the fuel cell of the present embodiment is more tolerant to high operating temperatures than the conventional fuel cell. Besides doing away with the need for additional cooling devices, the output power density 160 of the fuel cell of the present embodiment is further enhanced as high operating temperatures are favourable for the electro-chemical reaction occurring in the fuel cell.

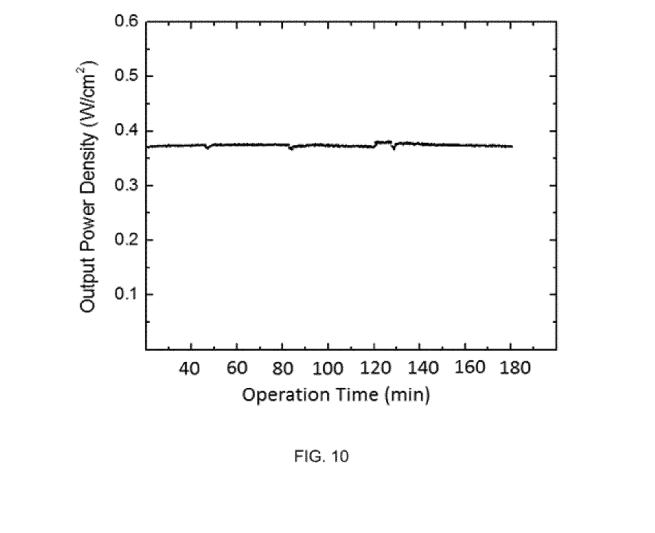

Referring now to FIG. 10, a graph of a chronoamperometry curve of a fuel cell in accordance with one embodiment of the present invention is shown. The chronoamperometry curve of the fuel cell was obtained by testing the fuel cell at a constant voltage of 0.5 volt (V) and a temperature of 62° C. As can be seen from FIG. 10, the output power density of the fuel cell stably remains at around 0.37 watt per square centimetre (W/cm²). No obvious power drop is observed during the measurement period of 180 minutes (min).

Due to dehydration of the membrane, conventional polymer electrolyte membrane (PEM) fuel cells are not able to operate stably at operating temperatures as high as 60° C. Output decay occurs as the membrane deteriorates.

However, as can be seen from the experimental results shown in FIG. 10, the fuel cell of the present embodiment does not encounter such a problem. The high output power density and high stability achieved by the fuel cell of the present embodiment at a high operating temperature indicate that the catalyst-coated membrane in the fuel cell of the present embodiment is kept at a stable and favourable saturation level. Little or no dehydration of the catalyst-coated membrane of the fuel cell of the present embodiment occurs during the high temperature operation. Therefore, coercive cooling is not required in fuel cell systems employing the fuel cell of the present embodiment. Cooling devices such as cooling fans can hence be eliminated from such systems. The fuel cell of the present embodiment is thus particularly suitable for portable power systems as these require simple electronic controls, less parasitic power consumption, less weight and a high power density.

As is evident from the foregoing discussion, the present invention provides a diffusion medium for use in a fuel cell, the diffusion medium having a distributed hydrophilic area formed on a hydrophobic area. This arrangement gives the diffusion medium both gas diffusion and water retention capabilities. Accordingly, when the diffusion medium of the present invention is incorporated into a fuel cell, these capabilities impart to the fuel cell a self-humidification function and tolerance to high operating temperatures. Consequently, the fuel cell employing the diffusion medium of the present invention is capable of being operated stably at high operating temperatures and increased current densities without the use of external humidifiers and cooling devices and also without compromising the output power density or durability of crucial parts of the fuel cell such as the catalysts and the membrane. Advantageously, this reduces the balance of plant requirements of the fuel cell and simplifies the control system for the fuel cell. It follows therefore that the present invention is particularly suitable for portable power applications where high power densities and simplified auxiliary component systems are desired.

While preferred embodiments of the invention have been illustrated and described, it will be clear that the invention is not only limited to the described embodiments. Numerous modifications, changes, variations, substitutions and equivalents will be apparent to those skilled in the art without departing from the scope of the invention as described in the claims.

Further, unless the context dearly requires otherwise, throughout the description and the claims, the words “comprise”, “comprising” and the like are to be construed in an inclusive as opposed to an exclusive or exhaustive sense; that is to say, in the sense of “including, but not limited to”.

1. A diffusion medium for use in a fuel cell, comprising:
a porous substrate having a first surface and a second surface, wherein the porous substrate is electrically conductive;
a microporous layer formed on the first surface of the porous substrate, the microporous layer providing a hydrophobic surface; and
a plurality of water-retaining portions formed on the surface of the microporous layer, the water-retaining portions defining a plurality of hydrophilic areas that partially cover the hydrophobic surface of the microporous layer.

2. The diffusion medium of claim 1, wherein the water-retaining portions comprise a hydrophilic polymer and an electron conductive material.

3. The diffusion medium of claim 2, wherein the electron conductive material is one or more of a group comprising a plurality of carbon nanoparticles, a plurality of carbon nanotubes, a graphite powder and a plurality of chopped carbon fibres.

4. The diffusion medium of claim 2, wherein the water-retaining portions further comprise a proton conductive polymer.

5. The diffusion medium of claim 4, wherein a ratio by weight of the electron conductive material to the proton conductive polymer is 1:3.

6. The diffusion medium of claim 4, wherein the proton conductive polymer is selected from a group comprising perfluorosulfonate ionomer, sulfonated polyphosphazene, sulfonated poly(ether ether ketone) (SPEEK) and derivatives thereof.

7. The diffusion medium of claim 1, wherein the hydrophilic area covers between about 2 percent (%) and about 40% of the hydrophobic surface of the microporous layer.

8. The diffusion medium of claim 7, wherein the hydrophilic area covers about 36% of the hydrophobic surface of the microporous layer.

9. The diffusion medium of claim 1, wherein the water-retaining portions are formed in a patterned arrangement on the hydrophobic surface of the microporous layer.

10. The diffusion medium of claim 9, wherein the patterned arrangement comprises a plurality of circular-shaped water-retaining portions distributed in a matrix over the hydrophobic surface of the microporous layer.

11. The diffusion medium of claim 9, wherein the patterned arrangement comprises a plurality of square-shaped water-retaining portions distributed in an array over the hydrophobic surface of the microporous layer.

12. The diffusion medium of claim 9, wherein the patterned arrangement comprises a plurality of water-retaining strips distributed in an array over the hydrophobic surface of the microporous layer.

13. The diffusion medium of claim 1, wherein the porous substrate is one of carbonized felt, carbon paper and carbon cloth.

14. The diffusion medium of claim 1, wherein the porous substrate is hydrophobic treated.

15. The diffusion medium of claim 1, wherein the microporous layer comprises a mixture of a plurality of carbon nanoparticles and a hydrophobic agent.

16. A fuel cell, comprising:
a membrane having an anode side and a cathode side;
a first diffusion layer provided on the anode side of the membrane, wherein the first diffusion layer is arranged to receive a fuel flow; and
a second diffusion layer provided on the cathode side of the membrane, wherein the second diffusion layer is arranged to receive an oxidant flow and wherein the second diffusion layer comprises a first diffusion medium according to claim 1.

17. The fuel cell of claim 16, wherein the water-retaining portions of the first diffusion medium are in contact with the cathode side of the membrane.

18. The fuel cell of claim 16, wherein the first diffusion layer comprises a second diffusion medium according to claim 1.

19. A method of making a diffusion medium for use in a fuel cell, comprising:
providing a porous substrate having a first surface and a second surface, wherein the porous substrate is electrically conductive;
forming a microporous layer on the first surface of the porous substrate, the microporous layer providing a hydrophobic surface; and
forming a plurality of water-retaining portions on the surface of the microporous layer, the water-retaining portions defining a plurality of hydrophilic areas that partially cover the hydrophobic surface of the microporous layer.

20. The method of making the diffusion medium of claim 19, wherein the step of forming the water-retaining portions on the microporous layer comprises applying a water retaining ink on the hydrophobic surface of the microporous layer to form the water-retaining portions.

21. The method of making the diffusion medium of claim 20, wherein the water retaining ink is applied on the hydrophobic surface of the microporous layer by one of painting, brushing, printing, spraying and screen printing.

22. The method of making the diffusion medium of claim 20, wherein the water retaining ink comprises an electron conductive material.

23. The method of making the diffusion medium of claim 22, wherein the water retaining ink further comprises a proton conductive polymer.

24. The method of making the diffusion medium of claim 23, wherein the water retaining ink comprises a mixture of a plurality of carbon nanoparticles in a 5 weight percent (wt %) perfluorosulfonate ionomer solution.

25. The method of making the diffusion medium of claim 24, wherein a ratio by weight of the carbon nanoparticles to perfluorosulfonate ionomer in the solution is 1:3.
